(19) United States
(12) Patent Application Publication
(10) Pub. No.: US 2003/0135585 A1
(43) Pub. Date: Jul. 17, 2003

(54) Network communication

(76) Inventor: Garritt C. Binder, Gilbert, AZ (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/044,334

(22) Filed: Jan. 11, 2002

(51) Int. Cl. G06F 15/16

(52) U.S. Cl. 709/219

(57) ABSTRACT

The disclosure describes a method of communication over a network. The method includes receiving at a server an HTTP (HyperText Transfer Protocol) request from a client over a network connection. After receiving notification of an event asynchronous to the receipt of the HTTP request, the server sends an HTTP response to the client identifying the asynchronous event.

### BACKGROUND

Computer networks, such as the Internet, enable computers to exchange information. To coordinate this exchange of information, many network computers use a protocol known as HTTP (HyperText Transfer Protocol). The HTTP protocol defines how network computers operating as servers respond to requests received from network computers operating as clients.

As an example, a client computer may send an HTTP GET message to a server. The GET message can request a particular network resource by specifying a URL (Universal Resource Locator) (e.g., www.cnn.com/news.html). Upon receipt of the GET message, a server retrieves and transmits the specified resource to the client in an HTTP response message.

The sequence described above is much like a series of falling dominos. That is, one action initiates the next. E.g., receipt of the GET message at the server causes the server to request retrieval of a file. Similarly, successful retrieval of the file causes the server to send a response to the client. More technically expressed, this is known as a synchronous process. This synchronous processing is very well suited for many Internet-based activities such as browsing web-pages. Unfortunately, this model does not readily embrace the concept of server initiated communication with a client.

### SUMMARY

In general, in one aspect, the disclosure describes a method of communication over a network. The method includes receiving an HTTP (HyperText Transfer Protocol) request from a client over a network connection, receiving notification of an event asynchronous to the receipt of the HTTP request, and sending an HTTP response to the client in response to the notification of the asynchronous event over the network connection.

Embodiments may feature one or more of the following. The HTTP request may be a GET or POST message. Asynchronous notification may be received via an API (Application Programmer Interface). The server notification may include identification of a client. Sending the response may include sending an event code and/or a file name. The method may further include sending an HTTP response to the client before receiving the asynchronous notification. For example, sending the response may occur before expiration of a connection time-out value.

In general, in another aspect, the disclosure describes a computer program product, disposed on a computer readable medium, for communication over a network. The program includes instructions for causing a processor to receive an HTTP (HyperText Transfer Protocol) request from a client over a network connection, receive notification of an event asynchronous to the receipt of the HTTP request, and send an HTTP response to the client in response to the notification of the asynchronous event over the network connection.

### BRIEF DESCRIPTION OF THE DRAWINGS

FIG. 1 is a diagram illustrating transmission of an HTTP (HyperText Transfer Protocol) message from a client to a server.

FIG. 2 is a diagram illustrating server notification of an asynchronous event by an external application.

FIG. 3 is a diagram illustrating client notification of the asynchronous event.

FIG. 4 is a flow-chart illustrating operation of a client and a server in the network communication system.

FIG. 5 is a diagram of a server.

### DETAILED DESCRIPTION

As described above, the HTTP (HyperText Transfer Protocol) protocol specifies how servers respond to client requests. In a traditional request/response sequence, the client essentially controls the timing and nature of the communication. E.g., “send me this resource when you get this message”. Oftentimes, however, it would be very advantageous for an HTTP server to communicate information of its choosing to a client at a time of its choosing. For example, a server operated by an airplane reservation service may initially send a web-page to a client depicting a seat selection chart for a particular flight. After sending this web-page, however, the server may receive notification of new reservations from other clients. Thus, over time, the original seating chart depicted by the client may become stale and inaccurate as seats depicted as available are reserved. Preferably, the server should be able to notify the client when seats are reserved, for example, to permit the client to update its seating chart display. Or, to generalize this hypothetical example, an HTTP server should be able to notify a client of events as they occur on the server's initiative, rather than that of the client.

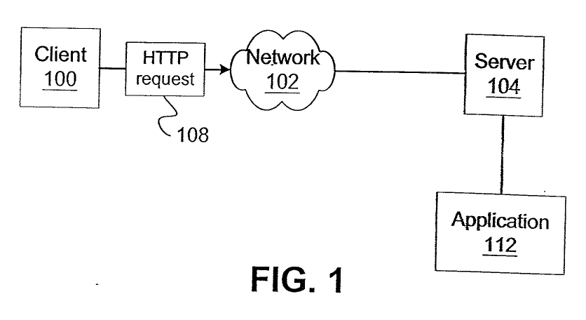

FIGS. 1 to 3 illustrate operation of a network communication system that permits a server 104 to send events 110 to a client 100 in real-time using standard HTTP services. Briefly, the system shown uses an initial HTTP request 108 from a client 100 to establish a client 100/server 104 connection. The system “holds-open” the connection, potentially, indefinitely while the server 104 awaits notification of an asynchronous event 110, for example, issued by an external application 112. The server 104 then uses the previously opened connection to send notification of the event 110 to the client 100.

The event 110 is asynchronous in that the timing of the event 110 is independent of the time of connection establishment or the time the HTTP request 108 is received by the server 104. Instead, the event 110 may occur, for example, when determined by the independent, on-going processing of the external application program 112. Such processing may have been initiated before receipt of the HTTP message 108 or establishment of the connection.

This approach of using HTTP messages to mimic server 104 initiated communication to clients 100 has a wide variety of advantages. For example, many managers often configure their network security systems (e.g., firewalls) to let HTTP requests 108 and responses 114 pass through relatively freely. Thus, since the clients 100 send and receive normal HTTP traffic, the clients 100 can participate in the system without firewall reconfiguration.

In greater detail, FIG. 1 depicts a client 100 initiating a transport level connection to a server 104 over a network 102 such as the Internet. This connection may be a persistent connection. While a persistent connection can enhance performance, the system does not rely on the availability of persistent connections to operate.

As shown, the client 100 uses the connection to send an HTTP request 108. The request 108 may be one of a variety of HTTP messages such as an HTTP GET or POST request. The request 108 may also include information identifying the client 100 or user agent (e.g., a username, account number, and/or IP address). A network computer may operate many clients 100 concurrently. Additionally, different network clients 100 may be associated with the same identifying information. That is, the same user may simultaneously use multiple HTTP clients. Events due the user may be distributed among the clients or broadcast to all.

While the request 108 may indicate an interest in receiving event 110 notification, the request 108 need not specify which events 110 are of interest or expected in the response. For example, to continue the hypothetical airline example, such a system may have a “SEAT RESERVED” event, a “SEAT UNRESERVED” event, a “FLIGHT CANCELLED” event, and so forth. The client 100 may not know which event 110 may occur next. In other words, the client's 100 request 108 can be thought of as communicating a general interest in events that occur without prior knowledge of which event will be sent over the established connection. Upon receipt of a response 114, the client can parse or otherwise interpret the received information to determine which event 110 occurred without prior knowledge of which event(s) will be sent, when the event(s) might be sent, or if events might be sent.

The HTTP request 108 may be configured to deal with many commonplace network features. For example, many network agents (e.g., a proxy) may handle an HTTP request before the request reaches a specified server 104. To speed responses to HTTP requests many of these network agents “cache” responses to previous requests for quick retrieval should the agent receive the same request again. Caching, however, could prematurely terminate a connection and/or falsely notify a client of an event multiple times. Thus, the HTTP request 108 should be configured to disable response caching features of agents that process the HTTP request 108 between and including the client 100 and server 104. For example, the request 108 may use ‘cache-control’ as specified by section 14.9 of the HTTP 1.1 specification or URL (Universal Resource Locator) formatting specifying an “un-cacheable” response.

For security, the request 108 may be scrambled (i.e., “encrypted”), for example, using SSL (Secure Sockets Layer) or other cryptographic techniques. Additionally, the request 108 may include extraneous information that makes decryption more difficult.

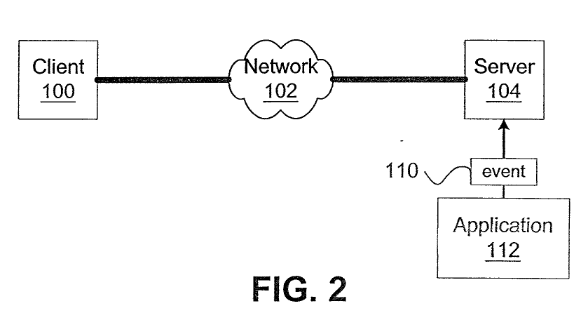

Referring to FIG. 2, after receipt of the request 108, the server 104 can determine if the request 108 is valid. For example, the server 104 can determine whether the request originates from a valid client 100 or user agent. Similarly, the server 104 can perform HTTP authentication. If the request 108 is not considered valid, the system can terminate the transport level connection.

For valid requests, the server 104 attempts to maintain the connection until needed. Potentially, many network agents (e.g., proxy, gateway, tunnel, or firewall) linking the client and server can terminate the connection. For example, many network agents “time-out” connections after some interval. Thus, the server 104 can track time-outs received for a given connection and learn when such time-outs occur. Based on this information, the server 104 can preemptively send a response to the client 100 before a time-out occurs that causes the client 100 to reestablish a connection. For example, the server 104 may send a “no-op” (no operation) response (e.g., a response of “HTTP 201 OK NO-OP”) to client 100 before a time-out occurs. Upon receipt, the client 100 can re-establish a client 100/server 104 connection.

While taking actions necessary to maintain or re-establish a connection, the server 104 awaits notification of an asynchronous event 110, for example, from the external application 112. The server 104 may receive notification of an event 110 in a variety of ways. For example, a server 104 method exposed by an API (Application Programmer Interface) may be invoked by a locally resident external application 112. Alternatively, the server 104 may expose methods for RPC (Remote Procedure Calls) or as a distributed object for network based notification from applications not residing locally.

The events 110 may be application 106 specific and may be encoded in a variety of ways (e.g., numeric codes or alphanumeric strings). For client/user specific events, the notification of the event 110 may include specification of the ID of a particular client or user agent. Alternatively, the server 104 may transmit events to a class of clients/users.

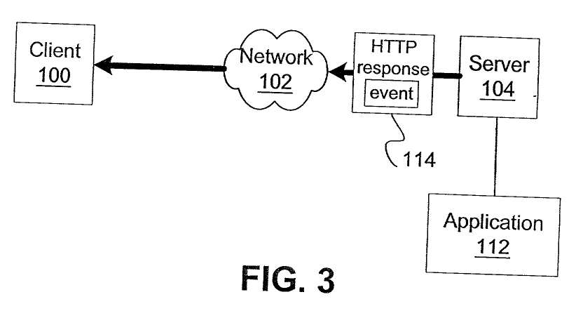

As shown in FIG. 3, after receiving the event 110, the server 104 can send an HTTP response 114 to the client 100 based on the event 110. The response 114 can notify the client of the event 110, for example, by including an event code or identifier in the response. In other schemes, the response 114 can include other event-based information such as the name of file now available at some site and so forth. The client 100 can react to the event 110, for example, by decoding or parsing information included in the response 114 and taking appropriate action.

To speed delivery, the server 104 response 114 may be relatively small. Additionally, like the request 108, the response may be encrypted using SSL and/or another cryptographic technique. Similarly, extraneous information may be included in this response 114 to make decryption more difficult.

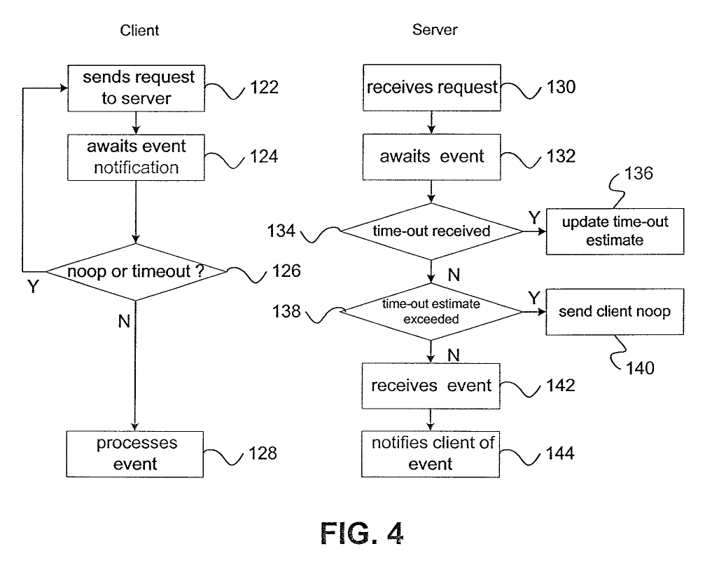

FIG. 4 illustrates a flow-chart of the network communication system. As shown, after a client sends 122 a request to the server (see FIG. 1), the client awaits 124 a server response notifying the client of an event (see FIG. 3). After the server receives 130 the request, the server awaits 132 notification of the asynchronous event (see FIG. 2). If no timeout 134 or other error occurs, the server receives 142 event notification and transmits 144 a response to the client over the connection. The client can then process 128 the received notification. The client may also establish a new connection to receive notification of other events.

As shown in FIG. 4, the server can also monitor the duration of the on-going connection. For example, the server can compare 138 the duration of the current connection to a time-out estimate. If the duration exceeds, meets, or nears the estimate, the server can preemptively send 140 a “no-op” response to the client. Receipt 126 of the no-op can trigger the client to reconnect 122 to the server. If a time-out occurs 134 before transmission of the “no-op”, the server can re-determine a suitable time-out estimate 136 to avoid a time-out in the future.

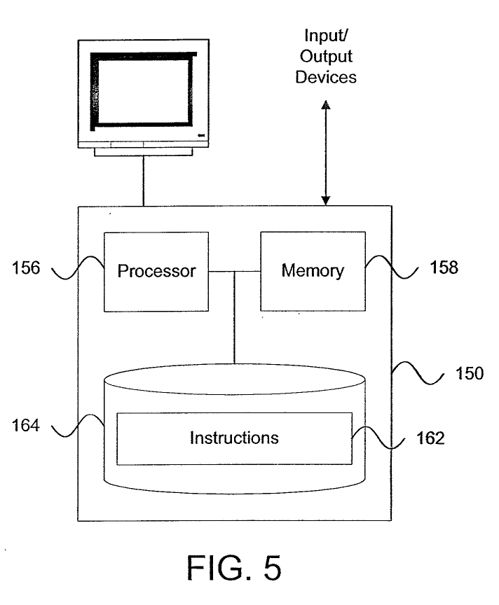

FIG. 5 illustrates a computer 150 for providing features described above. As shown, the computer 150 accesses instructions 162 that, for example, may correspond to 130-144 of FIG. 4. As shown, the computer 150 can include one or more processor(s) 156, memory 158, and a mass storage device 162 (e.g., CD-ROM or hard disk) storing the instructions. During the course of operation instructions 164 may be transferred from the mass storage device 162 to the processor 156 and/or memory 158 for processing.

The techniques described herein are not limited to a particular hardware or software configuration; they may find applicability in a wide variety of computing or processing environment. The techniques may be implemented in hardware or software, or a combination of the two. Preferably, the techniques are implemented in computer programs executing on programmable computers that each include a processor, a storage medium readable by the processor (including volatile and nonvolatile memory and/or storage elements), at least one input device, and one or more output devices.

Each program is preferably implemented in high level procedural or object oriented programming language to communicate with a computer system. However, the programs can be implemented in assembly or machine language, if desired. In any case the language may be compiled or interpreted language.

Each such computer program is preferably stored on a storage medium or device (e.g., CD-ROM, hard disk, or magnetic disk) that is readable by a general or special purpose programmable computer for configuring and operating the computer when the storage medium or device is read by the computer to perform the procedures described herein. The system may also be considered to be implemented as a computer-readable storage medium, configured with a computer program, where the storage medium so configured causes a computer to operate in a specific and predefined manner.

Other embodiments are within the scope of the following claims.

What is claimed is:

1. A method of communication over a network, the method comprising:
receiving at a server an HTTP (HyperText Transfer Protocol) request from a client over a network connection;
receiving at the server notification of an event asynchronous to the receipt of the HTTP request; and
sending an HTTP response to the client in response to the notification of the asynchronous event over the network connection.

2. The method of claim 1, wherein the HTTP request comprises: at least one of the following a GET message and a POST message.

3. The method of claim 1, wherein receiving at the server asynchronous notification comprises receiving notification via an API (Application Programmer Interface).

4. The method of claim 1, wherein the server notification comprises identification of a client.

5. The method of claim 1, wherein sending the response comprises sending an event code.

6. The method of claim 1, wherein sending the response comprises sending a file name.

7. The method of claim 1, further comprising sending an HTTP response to the client before receiving the asynchronous notification.

8. The method of claim 7, wherein sending the response before receiving the asynchronous notification comprises sending the response before expiration of a connection time-out value.

9. The method of claim 8, further comprising determining the connection time-out value.

10. A computer program product, disposed on a computer readable medium, for communication over a network, the program comprising instructions for causing a processor to:
receive an HTTP (HyperText Transfer Protocol) request from a client over a network connection;
receive notification of an event asynchronous to the receipt of the HTTP request; and
send an HTTP response to the client in response to the notification of the asynchronous event over the network connection.

11. The computer program of claim 10, wherein the HTTP request comprises: at least one of the following a GET message and a POST message.

12. The computer program of claim 10, wherein the instructions for causing the processor to receive asynchronous notification comprise instructions for causing the processor to receive notification via an API (Application Programmer Interface).

13. The computer program of claim 10, wherein the server notification comprises identification of a client.

14. The computer program of claim 10, wherein the instructions for causing the processor to send the response comprise instructions for causing the processor to send an event code.

15. The computer program of claim 10, wherein the instructions for causing the processor to send the response comprise instructions for causing the processor to send a file name.

16. The computer program of claim 10, further comprising instruction for causing the processor to send an HTTP response to the client before receiving the asynchronous notification.

17. The computer program of claim 16, wherein the instructions for causing the processor to send the response before receiving the asynchronous notification comprise instructions for causing the processor to send the response before expiration of a connection time-out value.

18. The computer program of claim 17, further comprising instructions for causing the processor to determine the connection time-out value.
